(19) United States
(12) Patent Application Publication
(10) Pub. No.: US 2014/0028955 A1
(43) Pub. Date: Jan. 30, 2014

(54) BACKLIGHT UNIT AND DISPLAY DEVICE

(71) Applicants: Shigenori Tanaka, Osaka-shi (JP); Yoshinobu Hirayama, Osaka-shi (JP); Toshihiro Yanagi, Osaka-shi (JP)

(72) Inventors: Shigenori Tanaka, Osaka-shi (JP); Yoshinobu Hirayama, Osaka-shi (JP); Toshihiro Yanagi, Osaka-shi (JP)

(73) Assignee: SHARP KABUSHIKI KAISHA, Osaka-shi, Osaka (JP)

(21) Appl. No.: 14/112,732

(22) PCT Filed: Apr. 16, 2012
(86) PCT No.: PCT/JP2012/060287

§ 371 Date: Oct. 18, 2013

(30) Foreign Application Priority Data
Apr. 22, 2011 (JP) 2011-096584

(51) Int. Cl. F21V 8/00

(52) U.S. Cl. CPC G02B 6/005; G02B 6/0053
USPC 349/65; 362/606

(57) ABSTRACT

Provided are (i) at least two light sources (4A and 4B), (ii) a light guide plate (2) having a light exit surface (SUF4), and (iii) an optical path changing member (1) which directly receives light emitted from the light exit surface (SUF4) and which has a light exit surface (SUF2) from which the light is directly emitted to a liquid crystal panel (5). The light emitted from the light exit surface (SUF2) has a luminance directivity in which luminance distribution is maximum in at least two directions other than a direction normal to a display screen of the liquid crystal panel (5).

### TECHNICAL FIELD

The present invention relates to a backlight unit, and a display device including the backlight unit.

### BACKGROUND ART

Recently, thin, lightweight, and low-power consumption display devices, as typified in liquid crystal display devices, have been in widespread use. Such display devices are often incorporated in, for example, mobile phones, smart phones, or laptop personal computers. Further, it has been expected that electronic papers will be rapidly developed and come into widespread use as much thinner display devices in the future.

Further, recently, so-called dual view display (hereinafter abbreviated to “DV display”), which enables a viewer to view different images on a single display, has been earnestly developed. A DV display is configured to display two different images simultaneously. A viewer can view the two different images on the DV display from respective specific different directions.

It is therefore preferable that light emitted from the DV display has luminance directivities in respective directions which enable the viewer to view the two different images.

Pixels themselves which constitute a liquid crystal panel do not emit light. Therefore, a luminance directivity of light emitted from the liquid crystal panel remarkably depends on a luminance directivity of backlight emitted by a backlight. Note that, as illustrated in (b) of FIG. 8, light emitted from a normal liquid crystal display 1000 that is not a DV display has a luminance directivity in a direction (indicated by an alternate long and short dash line O) of a viewing angle 0°.

An example of a technique regarding the luminance directivity of backlight emitted from the backlight is a backlight unit for use in a DV display (hereinafter simply referred to as a “DV backlight unit”) described in Patent Literature 1.

As illustrated in (a) of FIG. 8, the DV backlight unit includes (i) a light source 1011, (ii) a light guide plate 1012, (iii) a light diffusing sheet 1013, (iv) a prism sheet 1014 and a prism sheet 1015 which are provided between the light diffusing sheet 1013 and a liquid crystal panel, and (v) a reflection plate 1016. The prism sheet 1014 has a prism formation surface on which prisms are formed. The prism formation surface faces the light diffusing sheet 1013. Each of the prisms has a prism axis (a ridgeline of the prism) which is parallel to an up-and-down direction of a liquid crystal screen illustrated in (b) of FIG. 8. The prism sheet 1015 also has a prism formation surface on which prisms are formed. The prism formation surface faces the liquid crystal panel. Each of the prisms has a prism axis which extends along a direction perpendicular to the up-and-down direction.

The DV backlight unit, as configured above, can have high luminances in respective rightward and leftward directions of the liquid crystal screen.

Another example of the technique is a backlight unit described in Patent Literature 2.

As illustrated in (a) of FIG. 9, the backlight unit includes (i) a light guide plate 2022, (ii) a lens sheet 2021 having prisms 2026 arranged in rows, (iii) a reflection sheet 2025, (iv) a light source 2023, and (v) a light source 2024. The prisms 2026 of the lens sheet 2021 face a display panel, and are arranged so as to be orthogonal to long end surfaces of the light guide plate 2022, on which long end surfaces the respective light sources 2023 and 2024 are provided. (b) of FIG. 9 illustrates a luminance of the backlight unit thus configured above. In (b) of FIG. 9, (i) a symbol “K” illustrates a luminance of the backlight unit, which luminance is obtained in a case where each of the prisms 2026 has a vertex angle 90°, and (ii) a symbol “L” illustrates a luminance of a backlight unit which includes no lens sheet 2021. As is clear from the luminance illustrated by the symbol “K”, by including the lens sheet 2021 which has formed thereon the prisms 2026 each of which has the vertex angle of 90°, the backlight unit has a narrow viewing angle though having a high luminance. Note here that the viewing angle is an angle from a direction normal to a surface of the backlight unit. Each of the prisms 2026 is in a shape of an isosceles triangle. An angle between two sides of the isosceles triangle, which have the same length, is the vertex angle of the prism 2026.

### CITATION LIST

### Patent Literatures

Patent Literature 1
Japanese Patent Application Publication, Tokukai, No. 2009-86622 A (Publication Date: Apr. 23, 2009)
Patent Literature 2
Japanese Patent Application Publication, Tokukai, No. 2005-44642 A (Publication Date: Feb. 17, 2005)

### SUMMARY OF INVENTION

### Technical Problem

However, the above-described techniques have the following problems.

For example, the backlight unit having a luminance directivity in a direction of an viewing angle 0° (see (b) of FIG. 8) has the following problem: in a case where dual view display (hereinafter referred to as “DV display”) of a plurality of images is carried out on a display panel in respective directions of viewing angles ±45° from a direction normal to a display screen, a luminance of backlight emitted by the backlight unit is reduced by approximately 60% in the vicinity of the viewing angles ±45°. This causes a deterioration in display quality. In order to increase such a reduced luminance, it is necessary to increase the luminance of the backlight unit as a whole. This causes an unnecessary increase in power consumption of the backlight unit.

The DV backlight unit described in Patent Literature 1 includes at least three sheet-like members, i.e., the light diffusing sheet 1013, and the prism sheets 1014 and 1015 between the light guide plate 1012 and a display panel. It is therefore difficult to thin the DV backlight unit.

According to the backlight unit described in Patent Literature 2, each prism axis of the prisms 2026 of the lens sheet 2021 is parallel to a direction in which the light sources 2023 and 2024 emit light. For example, assume that light travels along side surfaces of respective prisms each of which is in a shape of a rectangular parallelepiped, which side surfaces face in parallel each other. On the assumption, an angle at which light enters the prisms is theoretically equal to an angle at which light is emitted from the prisms. On the other hand, according to the backlight unit described in Patent Literature 2, the prism axis of the prisms 2026 extends along a light traveling direction in which light emitted by the light sources 2023 and 2024 travels.

Therefore, a predetermined incident angle, at which light enters the lens sheet 2021 along the light traveling direction, is substantially equal to an angle at which light is emitted from the prisms 2026. As such, the backlight unit described in Patent Literature 2 has a problem that it is difficult to emit backlight having luminance directivities in different directions.

The present invention was made in view of the problems, and an object of the present invention is to provide, for example, a thin backlight unit which can emit backlight having luminance directivities in different directions.

### Solution to Problem

In order to attain the object, a backlight unit of the present invention is configured to include: at least two light sources which are provided so as to face each other; a light guide member having a first light exit surface, the light guide member (i) receiving light emitted by the at least two light sources and (ii) emitting the light from the first light exit surface; and an optical path changing member (i) directly receiving the light emitted from the first light exit surface and (ii) having a second light exit surface from which the light is emitted directly to a display panel that is externally provided, the optical path changing member for changing an optical path of the light passing through the optical path changing member, the light emitted from the second light exit surface having a luminance directivity in which luminance distribution is maximum in at least two directions other than a direction normal to a display screen of the display panel.

According to the configuration, the optical path changing member emits, from the second light exit surface, the light having the luminance directivity in which luminance distribution is maximum in the at least two directions other than the direction normal to the display screen of the display panel.

Therefore, unlike the backlight unit described in Patent Literature 2, the backlight unit of the present invention does not cause a problem that it is difficult to emit backlight having luminance directivities in different directions.

The optical path changing member directly receives light emitted from the first light exit surface of the light guide member, and then directly emits the light to the display device which is externally provided. In other words, the backlight unit of the present invention includes only one optical path changing member 1 as a sheet-like member between the display panel and the light guide member. Therefore, unlike the DV backlight unit described in Patent Literature 1, the backlight unit of the present invention does not cause a problem that it is difficult to reduce the thickness of the backlight unit.

As such, the backlight unit of the present invention, with its thickness reduced, can emit backlight having luminance directivities in different directions.

### Advantageous Effects of Invention

The backlight unit of the present invention is thus configured such that the optical path changing member emits, from the second light exit surface, the light having the luminance directivity in which luminance distribution is maximum in the at least two directions other than the direction normal to the display screen of the display panel.

Therefore, the backlight unit of the present invention brings about an effect that it is possible to emit backlight having luminance directivities in different directions while reducing the thickness of the backlight unit.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating an embodiment of a display system of the present invention.

FIG. 2 is a block diagram illustrating a configuration of a main part of the display system.

FIG. 3 is a view illustrating an embodiment of a backlight unit of the present invention.

FIG. 4 is a view illustrating another embodiment of the backlight unit of the present invention. (a) of FIG. 4 illustrates an example configuration of the backlight unit. (b) of FIG. 4 illustrates another example configuration of the backlight unit.

FIG. 5 is a view illustrating yet another example configuration of the backlight unit.

FIG. 6 is a view illustrating a relationship between a viewing angle and a luminance in DV display.

FIG. 7 is a view illustrating further yet another example configuration of the backlight unit.

(a) of FIG. 8 is a perspective view illustrating a structure of a conventional DV backlight unit. (b) of FIG. 8 is a view illustrating a relationship between a viewing angle and a luminance in normal display.

FIG. 9 is a view illustrating (i) a structure of a conventional backlight unit and (ii) how a viewing angle and a luminance correspond to each other. (a) of FIG. 9 is a perspective view illustrating the structure of the conventional backlight unit. (b) of FIG. 9 is a view illustrating how a luminance and a direction of light, which is emitted by the conventional backlight unit, correspond to each other.

### DESCRIPTION OF EMBODIMENTS

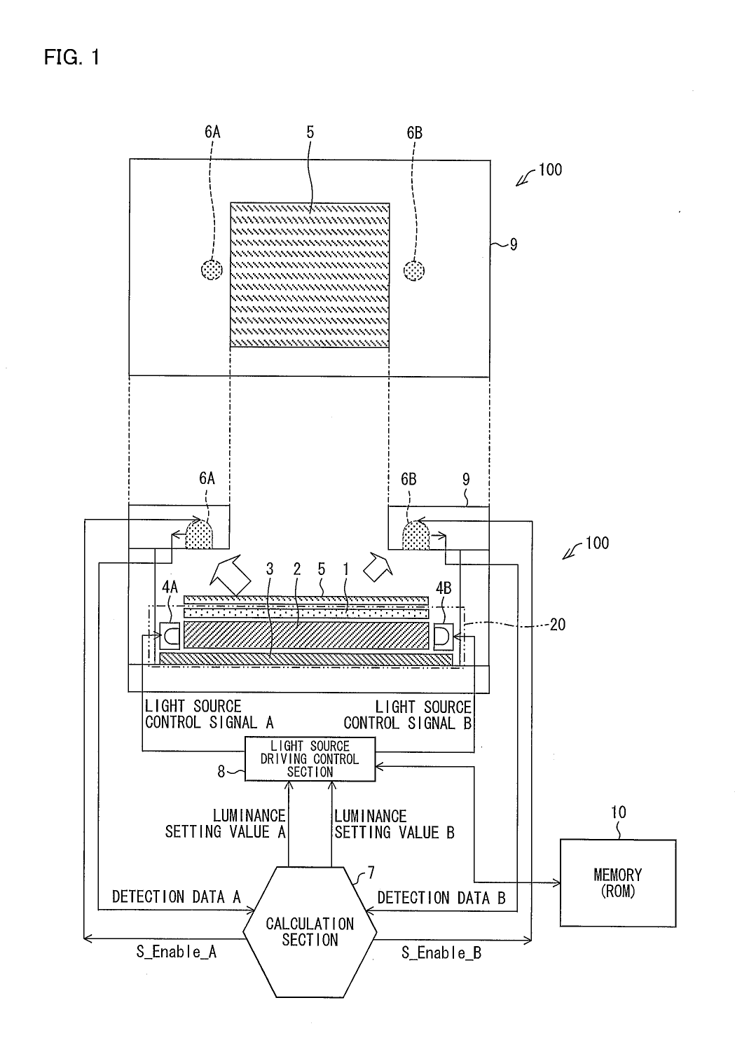

The following description will discuss an embodiment of the present invention with reference to FIGS. 1 through 7. Description of first configurations other than second configurations which will be described in specific items below is sometimes omitted where appropriate. Even if the first configurations are described in other items, the first configurations described in the other items are identical to the first configurations whose description is omitted. For convenience, members having functions identical to those described in items are given identical reference numerals, and descriptions of the respective members are omitted as appropriate.

[1. Configuration of Display System 100]

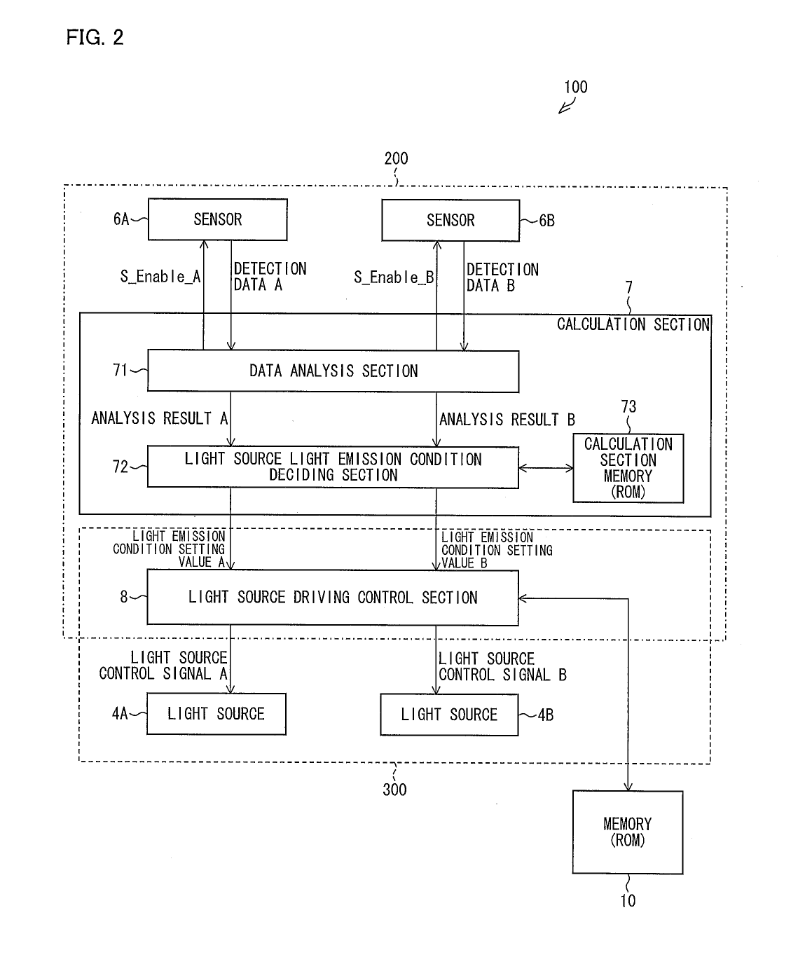

The following description will discuss, with reference to FIGS. 1 through 4 and FIG. 6, how a display system (display device) 100 in accordance with an embodiment of the present invention is configured. FIG. 1 is a block diagram illustrating an overall configuration of the display system 100. As illustrated in FIG. 1, the display system 100 includes a light source 4A, a light source 4B, a liquid crystal panel (display panel) 5, a sensor (luminance sensor) 6A, a sensor (luminance sensor) 6B, a calculation section 7, a light source driving control section 8, a frame 9, a memory 10, and a BL unit (backlight unit) 20. The light sources 4A and 4B, and the light source driving control section 8 constitute a backlight section 300 (see FIG. 2) for backlighting the liquid crystal panel 5. The sensors 6A and 6B, the calculation section 7, the light source driving control section 8, and the liquid crystal panel 5 constitute a display device section 200 (see FIG. 2).

Note that, as will be described below, the display system 100 can carry out (i) dual view display (hereinafter referred to as “DV display”) which displays two images simultaneously or (ii) quartet view display (hereinafter referred to as “CV display”) which displays four images simultaneously.

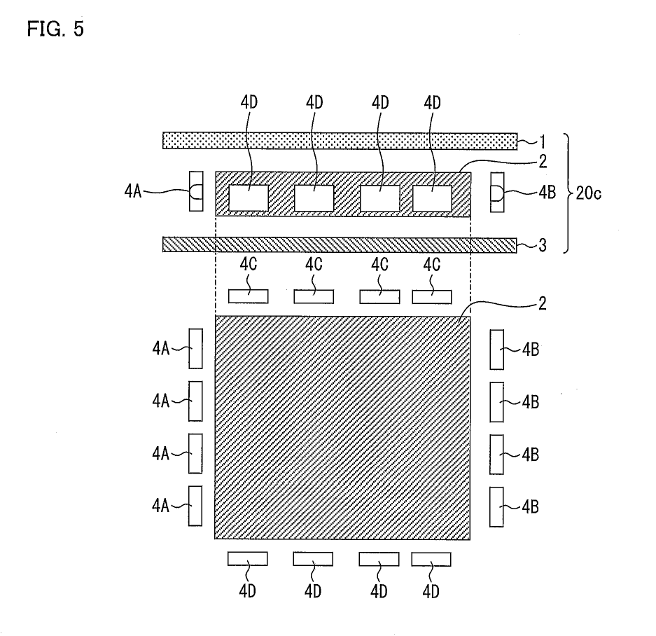

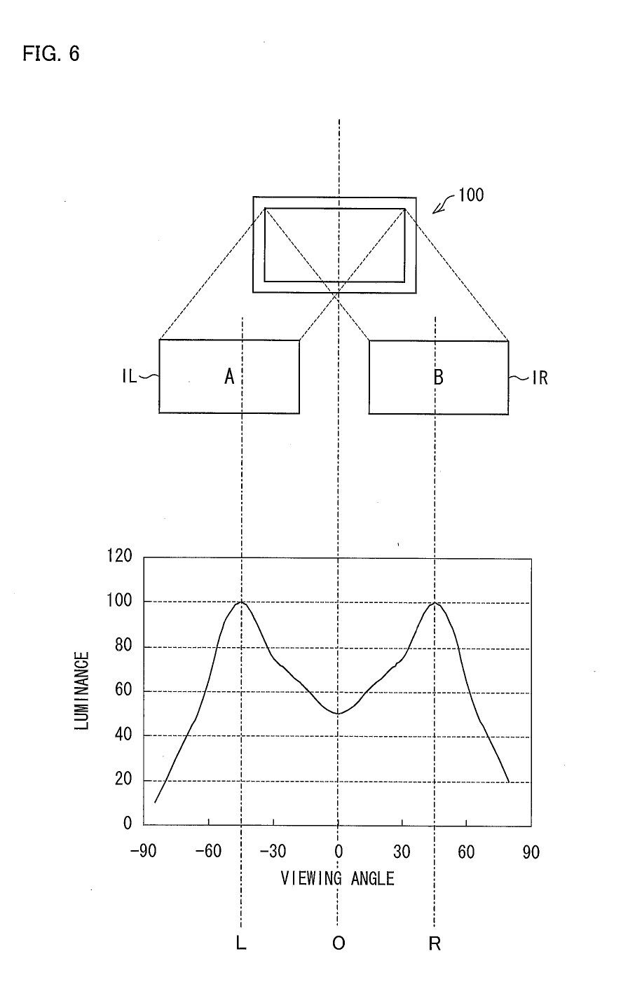

Note also that, in this specification, (i) a side of DV display, on which side a left-hand image IL is displayed, is called an “A side”, and a side of the DV display, on which side a right-hand image IR is displayed, is called “B side” (see FIG. 6), and in this patent application, (ii) sides of a CV display screen, on which sides a left-hand image, a right-hand image, a lower image, and an upper image are displayed, respectively, are called an “A side”, a “B side”, a “C side”, and a “D side” (see FIG. 5).

Note, however, that the display system 100 is not limited to the DV display or the CV display, provided that the display system 100 can display a plurality of images simultaneously.

[BL Unit 20]

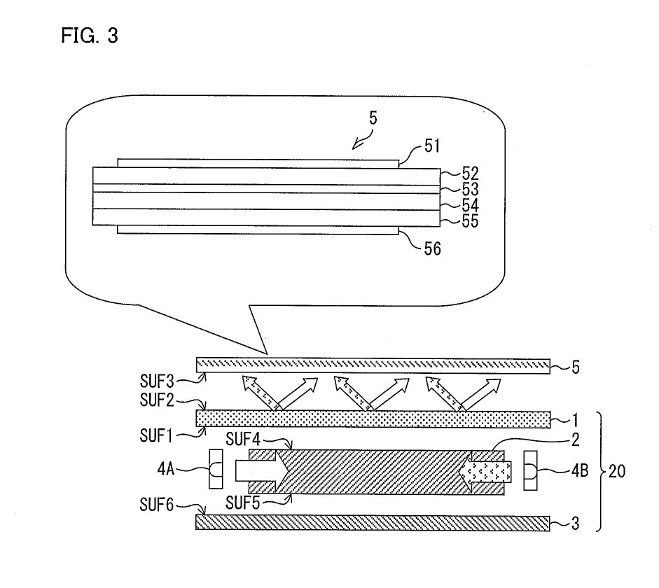

As illustrated in FIG. 3, the BL unit 20 includes an optical path changing member 1, a light guide plate (light guide member) 2, and a reflection plate (reflection member) 3.

Note here that, in this specification, (i) a “front surface” means a first surface on a side where the liquid crystal panel 5 displays an image (that is, a surface on a side where a user views the liquid crystal panel 5), and (ii) a “back surface” means a second surface opposite to the first surface. Note also that the liquid crystal panel 5 illustrated in FIG. 1 is a DV display panel.

The liquid crystal panel 5 has a back surface on which the optical path changing member 1 is provided. The optical path changing member 1 has a back surface on which the light guide plate 2 is provided. The light guide plate 2 has a back surface on which the reflection plate 3 is provided. The light guide plate 2 has side surfaces on which the respective light sources 4A and 4B are provided.

(Optical Path Changing Member 1)

The optical path changing member 1 is a kind of so-called optical sheets for, for example, reflecting, diffusing and/or converging light emitted from the light guide plate 2. The optical path changing member 1 of the present embodiment at least changes, due to its optical property, an optical path of light which has entered the optical path changing member 1.

As illustrated in FIG. 3, the optical path changing member 1 has (i) an incidence surface (light receiving surface) SUF1 which light enters, the light having been emitted by the light sources 4A and 4B which are provided so as to face each other in a right-and-left direction of FIG. 3 and (ii) a light exit surface SUF2 from which light is emitted, the light having entered from the incidence surface SUF1. The incidence surface SUF1 and the light exit surface SUF2 face each other in an up-and-down direction of FIG. 3.

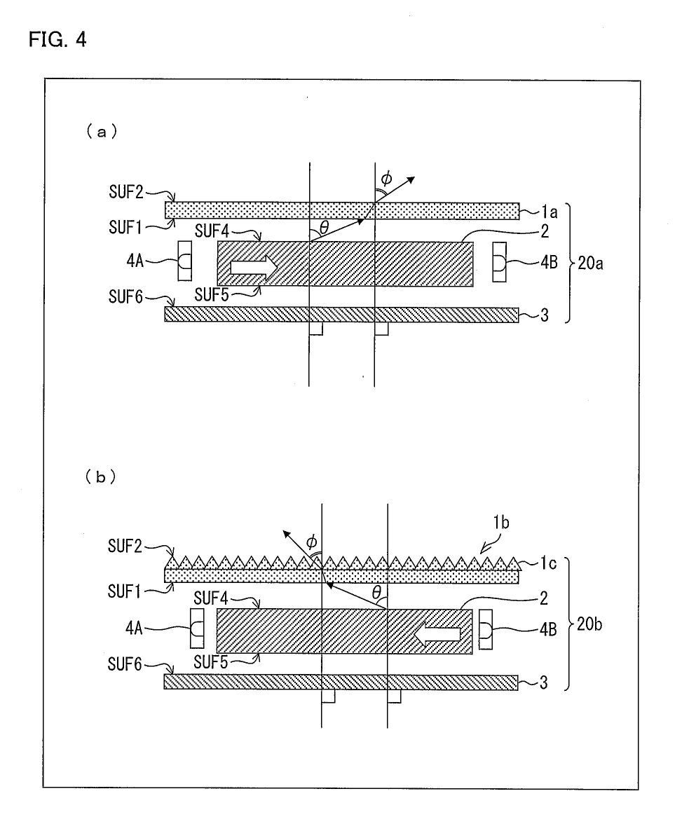

Further, as illustrated in (a) and (b) of FIG. 4, the optical path changing member 1 has such an optical property that Φ<θ where (i) Φ is a light exit angle (second light exit angle) from a facing direction in which at least the light sources 4A and 4B face each other, at which Φ light is emitted from the light exit surface SUF2 (second light exit surface) of the optical path changing member 1 and (ii) θ is a light exit angle (first light exit angle=an incidence angle at which light enters the incidence surface SUF1) from the facing direction, at which θ light is emitted from a light exit surface SUF4 (first light exit surface) of the light guide plate 2.

Examples of the optical path changing member 1 (optical sheet) having the optical property include (i) a light diffusing sheet 1a illustrated in (a) of FIG. 4 and (ii) a lens sheet 1b illustrated in (b) of FIG. 4.

(a) of FIG. 4 illustrates a configuration of a BL unit (backlight unit) 20a which employs the light diffusing sheet 1a as the optical path changing member 1. (a) of FIG. 4 illustrates a configuration of a BL unit (backlight unit) 20b which employs the lens sheet 1b as the optical path changing member 1.

(Light Diffusing Sheet 1a)

The light diffusing sheet 1a, illustrated in (a) of FIG. 4, has a surface (an incidence surface SUF1 or a light exit surface SUF2) having minute shapes or contains a light scattering material. Generally, the optical property (Φ<θ) of the light diffusing sheet 1a does not depend on direction. It is, however, possible to configure the light diffusing sheet 1a to have the optical property in a specific direction. In a case where the light diffusing sheet 1a is configured to have the optical property in the specific direction, it is preferable to configure the light diffusing sheet 1a to have the optical property in the facing direction.

Even in a case where the optical property of the light diffusing sheet 1a does not depend on direction, it can be said that the diffusing sheet 1a isotopically has the optical property (Φ<θ) though the lens sheet 1b (later described) has more isotopically has the optical property than the light diffusing sheet 1a. Therefore, the light diffusing sheet 1a is suitably applicable to an optical path changing member 1 for use in CV display to be later described (see FIG. 5).

More specifically, the light diffusing sheet 1a of the present embodiment is made from a transparent resin serving as a base material (medium), in which transparent resin a light scattering agent (light scattering fine particles) is(are) dispersed.

Examples of the transparent resin include thermoplastic resins and thermosetting resins such as a polycarbonate resin, an acrylic resin, a fluoric acrylic resin, a silicone acrylic resin, an epoxy acrylate resin, a polystyrene resin, a cycloolefin polymer, a methyl styrene resin, a fluorine resin, polyethylene terephthalate (PET), polypropylene, an acrylonitrile styrene copolymer, and an acrylonitrile polystyrene copolymer.

Examples of the light scattering agent (light scattering fine particles) include (i) transparent fine particles of an inorganic material and (ii) transparent fine particles of a resin. Examples of the transparent fine particles of the inorganic material include (i) fine particles of oxides such as silica (SiO₂), alumina (Al₂O₃), magnesium oxide (MgO), or titania, (ii) fine particles of calcium carbonate, and (iii) fine particles of barium sulfate.

Examples of the transparent fine particles of the resin include (i) particles of an acrylic resin, a styrene resin, an acrylic styrene resin, or these resins which have been crosslinked, (ii) particles of a melamine-formaldehyde resin, (iii) particles of polytetrafluoro-ethylene, a perfluoroalkoxy resin, or a fluororesin of a copolymer such as a copolymer of tetrafluoroethylene and hexafluoropropylene or a copolymer of polyfluorovinylidene and ethylene tetrafluoroethylene, and (vi) particles of a silicone resin.

Note here that the wavelength of visual light substantially falls within a range from 350 nm to 800 nm, and therefore, light scattering fine particles whose average particle diameter has an order equal to that of the wavelength of visual light (that is, an order of 100 nm) can scatter light. In other words, the light scattering fine particles should have a particle diameter of not less than 100 nm so as to scatter light. Further, it is preferable that each of the light scattering fine particles has a particle diameter whose order is larger than that of the wavelength of visual light, i.e., not less than 1 μm, so as to suitably scatter light. That is, the light scattering fine particles preferably have an average particle diameter of not less than 1 μm, more preferably have an average particle diameter of approximately 2 μm.

The transparent resin of the light diffusing sheet 1a contains approximately 5% by mass of the light scattering fine particles. Needless to say, how much the transparent resin contains the light scattering fine particles slightly varies depending on how much light should be scattered (which is defined by, for example, Haze). In a case where the transparent resin contains the light scattering fine particles in a mass much more than 5% by mass, Haze is unnecessarily increased. This causes an increase in distance for which light travels in the light diffusing sheet 1a, whereby a transmittance is remarkably reduced.

It is preferable that, in a case where the light diffusing sheet 1a employs the light scattering fine particles as a light scattering agent, the light diffusing sheet 1a has a thickness which falls within a range from 0.1 mm to 5 mm. This is because the light diffusing sheet 1a having the thickness can have a preferable optical property, i.e., optimal light diffusion and luminance. On the contrary, a light diffusing sheet 1a having a thickness of less than 0.1 mm cannot desirably scatter light. Further, a light diffusing sheet 1a having a thickness of more than 5 mm contains a large amount of resin. This causes the light diffusing sheet 1a to absorb light, whereby a luminance is reduced.

Note that the light diffusing sheet 1a of the present embodiment has a Haze of 75% and a total light transmittance of 86%. The light diffusing sheet 1a of the present embodiment preferably has a Haze of not less than 70% and a total light transmittance of not less than 50%.

This allows the light diffusing sheet 1a to have a light exit angle Φ of +45° in a case where the light guide plate 2 has a light exit angle θ of +70°±5° (a first light exit angle of not less than 65° but not more than 75°).

(Gas Bubble)

In a case where a thermoplastic resin is employed as the transparent resin, the thermoplastic resin can contain gas bubbles as a light scattering agent. Inner surfaces of the gas bubbles formed in the thermoplastic resin diffusely reflect light. How much the thermoplastic resin which contains gas bubbles scatters light is equal to or more than how much the transparent resin, in which light scattering fine particles are dispersed, scatters light. Therefore, in a case where the thermoplastic resin contains gas bubbles, it is possible to further reduce the thickness of the light diffusing sheet 1a.

Examples of the light diffusing sheet 1a made from the thermoplastic resin which contains gas bubbles include white PET and white PP. White PET is prepared as follows: a filler which is insoluble in PET, such as a resin, titanium oxide (TiO₂), barium sulfate (BaSO₄) or calcium carbonate, is dispersed in PET, and then the PET is extended by use of a biaxial orientation method so that gas bubbles are generated around the filler.

Note that the light diffusing sheet 1a made from the thermoplastic resin needs to be at least uniaxially extended. This is because gas bubbles can be generated around the filler by at least uniaxially extending the light diffusing sheet 1a.

Examples of the thermoplastic resin include (i) polyester resins such as an acrylonitrile polystyrene copolymer, polyethylene terephthalate (PET), polyethylene-2,6-naphlate, polypropylene terephthalate, polybutylene terephthalate, a cyclohexane dimethanol copolymer polyester resin, an isophthalic copolymer polyester resin, a sporoglycol copolymer polyester resin, and a fluorine copolymer polyester resin, (ii) polyolefin resins such as polyethylene, polypropylene, polymethylpentene, and an alicyclic olefin copolymer resin, (iii) an acrylic resin such as polymethyl methacrylate, and (iv) polycarbonate, polystyrene, polyamide, polyether, polyester amide, polyether ester, polyvinyl chloride, a cycloolefin polymer, copolymers thereof, and mixtures thereof. However, the thermoplastic resin is not limited to the above examples.

It is preferable that, the light diffusing sheet 1a which contains gas bubbles as a light scattering agent has a thickness which falls within a range from 25 μm to 500 μm.

It is not preferable that the light diffusing sheet 1a has a thickness of less than 25 μm. This is because such a light diffusing sheet 1a is so soft that it easily wrinkles during production or in the frame 9. It is neither preferable that the light diffusing sheet 1a has a thickness of more than 500 μm. This is because, due to an increase in stiffness, it becomes difficult, for example, to form the light diffusing sheet 1a in a shape of a roll, and to slit the light diffusing sheet 1a, though the light diffusing sheet 1a particularly has no problem with its optical property. That is, the light diffusing sheet 1a becomes less advantageous in thickness than a conventional light diffusing sheet.

(Minute Convexoconcave Structure)

The light diffusing sheet 1a can have an incidence surface SUF1 or a light exit surface SUF2 having a minute convexoconcave structure. The minute convexoconcave structure can be formed, for example, as follows: a pressure is applied to a metal mold having the minute convexoconcave structure by means of co-extrusion molding or injection molding so that (i) the metal mold comes into contact with a light diffusing sheet 1a in shaping the light diffusing sheet 1a and (ii) the minute convexoconcave structure is transferred to the light diffusing sheet 1a.

Alternatively, the minute convexoconcave structure can be formed on an incidence surface SUF1 or a light exit surface SUF2 of a light diffusing sheet 1a with use of a radiation curing resin such a UV (ultraviolet) curing resin. More specifically, the minute convexoconcave structure can be formed by forming, by means of UV, a convexoconcave shape on the incidence surface SUF1 or the light exit surface SUF2 of the light diffusing sheet 1a which has been formed in a shape of a plate by means of co-extrusion.

A surface state of the incidence surface SUF1 or the light exit surface SUF2 is often numerically indicated by roughness of a convexoconcave shape. Note here that the surface state is indicated by Haze and convexoconcave intervals Sm (hereinafter referred to as “Sm”). Haze is defined by JIS K 7136. Specifically, the surface state is indicated by an average of five measurements obtained by measuring the roughness of the incidence surface SUF1 or the light exit surface SUF2 five times by use of a Haze measuring device. Sm is defined by surface roughness standards JIS B0601-2001, and is an average of measurements obtained by measuring the roughness of the incidence surface SUF1 or the light exit surface SUF2 by use of a contact-type surface roughness measuring device under a condition where a cut-off value is 2.0 mm.

A numerical increase in Haze causes an increase in scattering of light on the incidence surface SUF1 or the light exit surface SUF2. On the contrary, a numerical decrease in Haze causes a decrease in scattering of light on the incidence surface SUF1 or the light exit surface SUF2. A numerical decrease in Sm causes the incidence surface SUF1 or the light exit surface SUF2 to become a more minute convexoconcave surface. Light is less scattered on a surface having a Haze of less than 20%.

A surface having an Sm of less than 300 μm has small convexoconcave intervals, but is not rough enough for light to be scattered. Therefore, light is less scattered on the surface. On the other hand, a surface having an Sm of more than 900 μm has large convexoconcave intervals, and is rough. Therefore, light is more scattered on the surface, but a front luminance is reduced.

An incidence surface SUF1 or a light exit surface SUF2 having a regular roughness is more advantageous than a surface having an irregular roughness in that the incidence surface SUF1 or the light exit surface SUF2 can bring about a stable scattering effect and can be easily produced.

Haze can be adjusted by various methods. In a case where a convexoconcave shape is physically formed, Haze can be adjusted by adjusting a state of a surface of a metal mold, and then transferring the convexoconcave shape by means of injection molding or extrusion molding in in-line. Alternatively, Haze can be adjusted by thermally pressing a formed light diffusing sheet or blasting an abrasive to the formed light diffusing sheet in off-line. In a case where a light scattering agent is bled-out under an extrusion condition, Haze can be adjusted by adjusting a concentration and/or a particle diameter of light scattering fine particles, and a thickness of a light scattering layer.

According to an extrusion method, an extrusion device extrudes a thermally-melted thermoplastic resin from a T-die to form a plate-like light diffusing sheet. A multilayer plate is formed by use of a co-extrusion method is employed. According to the co-extrusion method, a plurality of extrusion devices extrude a thermally-melted thermoplastic resin from respective multilayer dies such as feed block dies or manifold dies to form the multilayer plate.

(Lens Sheet 1b)

The lens sheet 1b illustrated in (b) of FIG. 4 is configured such that (i) a plurality of prisms 1c are arranged in rows on a light exit surface SUF2 and (ii) ridgelines (prism axes) of the prisms 1c are vertical to the facing direction in which the light sources 4A and 4B face each other, whereby Φ<θ is satisfied where Φ is a light exit angle (second light exit angle) of the light emitted from the light exit surface SUF2 after entering the lens sheet 1b at a predetermined incidence angle along a light traveling direction from the light sources 4A and 4B, and θ is a light exit angle (first light exit angle=an incidence angle at which light enters the incidence surface SUF1) of the light emitted from the light exit surface SUF4B of the light guide plate 2. Therefore, unlike the backlight unit described in Patent Literature 2, such a problem is not caused that it is difficult to emit backlight having luminance directivities in different directions.

Note that each of the prisms 1c has (i) an isosceles triangular cross section, (ii) a vertex angle (prism vertex angle) which falls within a range from 80° to 100°, and (iii) a refractive index of 1.5. The lens sheet 1b having such prisms 1c can attain a light exit angle Φ of 45°, in a case where the light guide plate 2 has a light exit angle θ of 65°±5° (a first light exit angle of not less than 60° but not more than 70°). Note that as the refractive index of the lens sheet 1b is increased, the light exit angle Φ gets closer to 0°.

According to the BL unit 20 of the present embodiment, the optical path changing member 1 thus has the optical property in which the light exit angle Φ from the facing direction is smaller than the incidence angle θ from the facing direction. Therefore, as illustrated in FIG. 3, light from the light source 4A can be emitted as backlight which has a luminance directivity in a rightward direction (a direction toward the A side) that is at an angle (for example, a viewing angle +45°) to a direction normal to the light exit surface SUF2. Light from the light source 4B can be emitted as backlight which has a luminance directivity in a leftward direction (a direction toward the B side) that is at an angle (for example, a viewing angle −45°) to the direction normal to the light exit surface SUF2. Note that, in this specification, (i) an angle at which the liquid crystal panel 5 is viewed right in front of the liquid crystal panel 5 is a viewing angle 0°, (ii) an angle from the viewing angle 0° toward the A side is indicated by an angle of “+”, and (iii) an angle from the viewing angle 0° toward the B side is indicated by an angle of “−”.

Therefore, unlike the backlight unit described in Patent Literature 2, the BL unit 20 of the present embodiment does not cause a problem that it is difficult to emit backlight having luminance directivities in different directions, though the backlight unit described in Patent Literature 2 causes the problem because the axis of the prisms 2026 arranged in rows extends along a direction in which light emitted by the light sources 2023 and 2024 travels.

Further, as illustrated in FIGS. 3 and 4, the liquid crystal panel 5, which is externally provided, is directly irradiated with light emitted from the light exit surface SUF2 of the optical path changing member 1, the light diffusing sheet 1a, or the lens sheet 1b. In other words, the BL unit 20, 20a or 20b is configured to include only one (1) optical path changing member 1, one (1) light diffusing sheet 1a or one (1) lens sheet 1b as a sheet-like member between the liquid crystal panel 5 and the light guide plate 2 (later described). Therefore, unlike the DV backlight unit described in Patent Literature 1, the BL units 20, 20a and 20b do not cause a problem that it is difficult to thin the BL units 20, 20a and 20b.

As such, the BL unit 20, with its thickness reduced, can emit backlight having luminance directivities in different directions.

(Light Guide Plate 2)

The light guide plate 2 receives light emitted from the light sources 4A and 4B, and emits the light from the light exit surface SUF4 to the incidence surface SUF1 of the optical path changing member 1.

More specifically, the light guide plate 2 is a transparent resin plate for converting linear light emitted by the light sources 4A and 4B, so as to provide a surface light source which illuminates the liquid crystal panel 5.

Light which has entered the light guide plate 2 from the light source 4A is emitted from a front surface of the light guide plate 2 at an angle corresponding to, for example, a viewing angle +70°±5° (see FIG. 4). On the other hand, light which has entered the light guide plate 2 from the light source 4B is emitted from the front surface of the light guide plate 2 at an angle corresponding to, for example, a viewing angle −70°±5° (see FIG. 4).

The light guide plate 2 is in a shape of a plate (a rectangular parallelepiped). The light exit surface SUF4 (a bottom surface SUF5) is in a shape of a rectangle. The light guide plate 2 has a thickness which falls within a range from 0.2 mm to 3 mm. Note, however, that the thickness of the light guide plate 2 is not limited to the range.

The light guide plate 2 has a plate-like shape in the present embodiment. However, the light guide plate 2 may have various shapes such as wedge-like shapes and ship-like shapes. Moreover, the light guide plate 2 may be made of a synthetic resin having a high transmittance, such as a methacrylic resin, an acrylic resin, a polycarbonate resin, a polyester resin, or a vinyl chloride resin. The light guide plate 2 is configured such that (i) the light exit surface SUF 4 is mirror-surfaced and (ii) the bottom surface SUF 5 is rough-surfaced.

The bottom surface 5 of the light guide plate 2 is prism-processed or dot-processed, in order to have uniform luminance or improved luminance.

Specifically, the light exit surface SUF4 has (i) a thinly-formed convexoconcave shape in the vicinity of the light sources 4A and 4B (in opposite end parts of the light guide plate 2) and (ii) a densely-formed convexoconcave shape far from the light sources 4A and 4B (at and around the center of the light guide plate 2) so that light is uniformly emitted from the light exit surface SUF4. Note, however, that the light exit surface SUF4 is not limited to such convexoconcave shapes. The light guide plate 2 of the present embodiment thus configured above allows light to be emitted diagonally forward left and diagonally forward right (see FIG. 3).

The formation of such convexoconcave shapes on the bottom surface SUF5 of the light guide plate 2 may be carried out, for example, (i) by injection-molding process to perform injection molding with use of a mold for the convexoconcave shapes or (ii) by a process to form a light guide member having a flat surface by injection molding or casting, and print special ink on the light guide member by screen printing, so that protrusions are formed on the light guide member.

(Reflection Plate 3)

The reflection plate 3 is a light reflecting member for reflecting light leaked from the bottom surface SUF 5 of the light guide plate 2. The reflection plate 3 has a flat surface.

The reflection plate 3 is (i) a film of a polyester resin or a polyolefin resin or (ii) a white film. The white film is prepared by whitening a plastic resin by adding therein a pigment such as titanic oxide, barium sulfate, calcium carbonate, aluminum hydroxide, magnesium carbonate, or aluminum oxide before forming the plastic resin into a film or a sheet, and then forming the film or the sheet from the plastic resin. It is possible to (i) add an inorganic filler such as calcium carbonate or titanic oxide into a resin, (ii) form a film from the resin, and then (iii) further process the film by extending the film and forming a large number of micro voids in the film.

(Light Sources 4A and 4B)

The light source 4A is positioned to emit light to the light guide plate 2 A from the B side. The light source 4B is positioned to emit light to the light guide plate B from the A side. That is, the light sources 4A and 4B are provided on the opposite sides as illustrated in FIG. 3, in which they are provided on left and right sides oppositely. Moreover, the light of the light source 4A is emitted in a right direction (the B side), and the light of the light source 4B is emitted in a left direction (the A side). With this configuration, it is possible to attain in-plane uniformity in luminance of the backlight, and lateral symmetry of light direction angle distribution of illumination.

Moreover, even though the light sources 4A and 4B are LEDs (Light Emitting Diodes) in the present embodiment, the light sources 4A and 4B may be a surface light source such as a CCFT (Cold Cathode Fluorescent Tube) or an electroluminescence. The light sources are at least two independent LEDs herein. However, in a case of the CCFT, the light sources 4A and 4B may be constituted by a single fluorescent tube having a U-like shape, so that the light sources 4A and 4B are continuous. Moreover, the light sources 4A and 4B may be a pair of L-shaped fluorescent tubes.

Moreover, each of the light sources 4A and 4B may be provided with a reflector (not illustrated). The reflector has a parabolic shape internally, and each of the light sources 4A and 4B is provided at a focus part of the parabolic shape.

(Liquid Crystal Panel 5)

The Liquid crystal panel 5 is a display panel capable of performing multi-view display for a plurality of images. As illustrated in FIG. 3, the liquid crystal panel 5 has a light illumination surface SUF3 which is directly illuminated, via the optical path changing member 1, with light emitted from the light exit surface 4B of the light guide plate 2. The liquid crystal panel 5 includes a polarizing plate 51, a polarizing plate 56, a parallax barrier 52, a bonding layer 53, a CF (Color Filter) substrate 54, and a TFT (Thin Film Transistor) substrate 55.

Here, the liquid crystal panel 5 is configured such that a display region is backlighted on the A side with light emitted from the optical path changing member 1 receiving the light of the light source 4A via the light guide plate 2. As a result, an image displayed on the display region on the A side has a luminance peak at a viewing angle 45°.

On the other hand, the liquid crystal panel 5 is configured such that a display region is backlighted on the B side with light emitted from the optical path changing member 1 receiving the light of the light source 4B via the light guide plate 2. As a result, an image displayed on the display region on the B side has a luminance peak at a viewing angle −45°.

With this configuration, the luminance peak of the image displayed on the A side of the liquid crystal panel 5 and the luminance peak of the image displayed on the B side of the liquid crystal panel 5 are obtained in different directions.

Therefore, the display system 100 can display respective images on the A side and the B side of the liquid crystal panel 5 with luminance peaks at desired viewing angles, thereby improving the display quality of the images, respectively.

(Polarizing Plates 51 and 56)

The polarizing plates 51 and 56 each includes (i) a polarizer base material in which polarizing elements are present, (ii) base substrates (not illustrated) sandwiching the polarizer base material, (iii) a protective film (not illustrated) on one side, and (iv) an exfoliate film (not illustrated) for bonding the polarizing plate to a glass substrate on the other side.

The polarizing plates 51 and 56 are so thin that their thickness in total will be approximately in a range of 0.12 mm to 0.4 mm even if laminated in about 10 layers. The polarizer base material in which the polarizing elements are present is such that the polarizing elements are iodine or dichroic dye, which causes a polarizing effect. The polarizer base material is polyvinyl alcohol (PVA, Polyvinyl Alcohol). The polarizing elements are contained in the polarizer base material. The base substrate for protecting the polarizer base material is triacetyl cellulose, (TAC, Cellulose triacetate). On one side of the exfoliate film, which side faces the base substrate, an adhesive layer is applied. In adhering the polarizing plate to a glass substrate, the exfoliate film is peeled off from the adhesive layer, and then the polarizing plate is adhered to the glass substrate via the adhesive layer.

(Parallax Barrier 52)

The parallax barrier 52 is an optical member, in which light transmitting regions and light shielding regions are formed in stripes. By the parallax barrier 52, a plurality of images to be displayed is separated for corresponding display regions, individually.

For example, as illustrated in FIG. 6, the parallax barrier 52 enables a plurality of users to view different left-hand image IL (A side) and right-hand image IR (B side) in respective specific directions of a viewing angle L and a viewing angle R. That is, the parallax barrier 52 allows so-called DV display to be performed.

(Bonding Layer 53)

The boding layer 53 is a transparent resin layer (such as an acrylic resin) for bonding the parallax barrier 52 and the CF substrate 54. Because the parallax barrier 52 cannot function as a parallax barrier if the parallax barrier 52 and the CF substrate 54 are bonded in contact with each other, the bonding layer 53 provides an adequate distance between the parallax barrier 52 and the CF substrate 54. It is only required that the distance be sufficient for allowing DV display.

(CF Substrate 54)

The CF substrate 54 is configured such that (i) a coloring layer for transmitting light in red (R), green (G), or blue (B) for a corresponding pixel, and a black matrix (BM) are provided on a substrate and (ii) a protective film is provided on the coloring layer. The coloring layer is made from a coloring material applied in micropattern on the CF substrate 54, or from a coloring film. The coloring layer may be of a pigment type or a dye type. The BM layer is provided to prevent (i) light leakage in black display and (ii) color mixing between adjacent colors. The BM layer prevents photo-electric current from being generated due to light irradiation onto the TFT substrate 55. In case where a photosensitive material is used to fix the coloring material, the photosensitive material is mixed in the coloring material, so that the coloring material can be fixed. To form a thin BM layer of approximately 0.1 μm, metal chrome is popular. Other than that, carbon, titanium, nickel, etc. are used to form a BM layer. In gaps formed within the BM layer, each color of the coloring layer is formed in a predetermined pattern, and the coloring layer has a thickness thicker than the BM layer by about 1.2 μm. For a high-resolution screen, the pattern of the color layer often has a stripe configuration. For a low-resolution screen, the pattern of the color layer favorably has a delta configuration for the sake of attaining good image quality impression.

(Sensors 6A and 6B)

As illustrated in FIG. 1, the sensors 6A and 6B are provided on a front side of the liquid crystal panel 5, that is, on that side of the liquid crystal panel 5 on which the liquid crystal panel 5 displays an image. The sensors 6A and 6B are provided within the frame 9 serving as a housing. The sensors 6A and 6B are luminance sensors for sensing luminance of light entering the sensors.

In the present embodiment, the sensor 6A is provided on an optical path of the light emitted from the display region on the A side of the liquid crystal panel 5. The sensor 6A measures the luminance of the light entering the sensor 6A, and provides a result of the measurement to the calculation section 7 as detection data A.

The sensor 6B is provided on an optical path of the light emitted from the display region on the B side of the liquid crystal panel 5. The sensor 6B measures the luminance of the light entering the sensor 6B, and provides a result of the measurement to the calculation section 7 as detection data B, which is the other detection data than the detection data A.

[Calculation Section 7]

FIG. 2 is a block diagram illustrating the calculation section 7 and constituent elements relating to the calculation section 7.

As illustrated in FIG. 2, the calculation section 7 includes a data analysis section 71, a light source light emission condition deciding section 72, and a calculation section memory 73.

In the following, operations of the calculation section 7 and the constituent elements are discussed.

By way of example, the following discusses a case where an image displayed on the A side of the liquid crystal panel 5 is brighter than that displayed on the B side of the liquid crystal panel, as indicated by sizes of outline arrows in FIG. 1.

(Data Analysis Section 71)

The data analysis section 71 is configured to send a measurement command signal S_Enable_A to the sensor 6A. Moreover, the data analysis section 71 is configured to send a measurement command signal S_Enable_B to the sensor 6B.

The sensor 6A receives the measurement command signal S_Enable_A, and then starts the measurement of the luminance. The sensor 6A sends the result of the measurement to the data analysis section 71 as the detection data A. The sensor 6B receives the measurement command signal S_Enable_B, and then starts the measurement of the luminance. The sensor 6B sends the result of the measurement to the data analysis section 71 as the detection data B.

The data analysis section 71 receives the detection data A and B. The data analysis section 71 performs AD (Analog-Digital) conversion and denoising to the detection data A, thereby obtaining an analysis result A. Then, the data analysis section 71 sends the analysis result A to the light source light emission condition deciding section 72. The data analysis section 71 also performs AD conversion and denoising to the detection data B, thereby obtaining an analysis result B. Then, the data analysis section 71 sends the analysis result B to the light source light emission condition deciding section 72.

(Light Source Light Emission Condition Deciding Section 72)

The light source light emission condition deciding section 72 receives the analysis results A and B. The light source light emission condition deciding section 72 compares (i) the luminance value measured by the sensor 6A and indicated by the analysis result A and (ii) the luminance value measured by the sensor 6B and indicated by the analysis result B, so as to find out which one is larger than the other. In this example, since the image displayed on the A side of the liquid crystal panel 5 is brighter than that displayed on the B side of the liquid crystal panel 5, the luminance value measured by the sensor 6A and indicated by the analysis result A is greater than the luminance value measured by the sensor 6B and indicated by the analysis result B.

Here, the calculation section memory 73 is, for example, a ROM (Read Only Memory). The calculation section memory 73 stores therein in advance a look-up table prescribing a relationship between results of the comparison and whether to increase or decrease values of currents to be supplied to the light sources 4A and 4B.

The light source light emission condition deciding section 72 reads out the look-up table from the calculation section memory 73.

The look-up table has information for such a command that the current value of the current to be supplied to the light source 4A be decreased by a predetermined value, when the luminance value indicated by the analysis result A is greater than the luminance value indicated by the analysis result B. Moreover, the look-up table has information for such a command that the current value of the current to be supplied to the light source 4A be increased by a predetermined value, when the luminance value indicated by the analysis result A is smaller than the luminance value indicated by the analysis result B.

According to the information contained in the look-up table, the light source light emission deciding section 72 sends a light emission condition setting value A to the light source driving control section 8, the light emission condition setting value A decreasing or increasing by a predetermined value the current value of the current to be supplied to the light source 4A.

That is, when the luminance value indicated by the analysis result A is greater than the luminance value indicated by the analysis result B, the light emission condition setting value A is to command the light source driving control section 8 to decrease by a predetermined value the current value of the current to be supplied to the light source 4A. On the other hand, when the luminance value indicated by the analysis result A is smaller than the luminance value indicated by the analysis result B, the light emission condition setting value A is to command the light source driving control section 8 to increase by a predetermined value the current value of the current to be supplied to the light source 4A. Note that in this example, since the luminance value indicated by the analysis result A is greater than that indicated by the analysis result B, the light emission condition setting value A is to command the light source driving control section 8 to decrease by a predetermined value the current value of the current to be supplied to the light source 4A.

On the contrary, the look-up table may be configured such that the look-up table has information for such a command that the current value of the current to be supplied to the light source 4B be increased by a predetermined value, when the luminance value indicated by the analysis result A is greater than the luminance value indicated by the analysis result B. Further, the look-up table may be configured such that the look-up table has information for such a command that the current value of the current to be supplied to the light source 4B be decreased by a predetermined value, when the luminance value indicated by the analysis result A is smaller than the luminance value indicated by the analysis result B. In these cases, the light source light emission condition deciding section 72 sends a light emission condition setting value B to the light source driving control section 8, the light emission condition setting value B increasing or decreasing by a predetermined value the current value of the current to be supplied to the light source 4B, like the light emission condition setting value A increasing or decreasing by a predetermined value the current value of the current to be supplied to the light source 4A.

[Light Source Driving Control Section 8]

The light source driving control section 8 receives the light emission condition setting value A or B.

The light source driving control section 8 may be, for example, a general LED driving circuit for supplying a current to the light sources 4A and 4B, thereby driving the light sources 4A and 4B.

Therefore, the light source driving control section 8 can easily generate a light source control signal A according to the light emission condition setting value A, the light source control signal A being the current to be applied to the light source 4A. That is, in this example, the light source driving control section 8 decreases a current value of the light source control signal A according to the light emission condition setting value A.

Likewise, the light source driving control section 8 can easily generate a light source control signal B according to the light emission condition setting value B, the light source control signal B being the current to be applied to the light source 4B. That is, in this example, the light source driving control section 8 increases a current value of the light source control signal B according to the light emission condition setting value B.

The operation as described above is repeated until a difference between the luminance value indicated by the analysis result A and the luminance value indicated by the analysis result B becomes less than a predetermined value (for example, a value by which the current value of the current to be supplied to the light source 4A or 4B is increased or decreased by a single current value adjusting operation). The difference between the luminance value indicated by the analysis result A (the luminance value measured by the sensor 6A) and the luminance value indicated by the analysis result B (the luminance value measured by the sensor 6B) may be calculated out from the analysis results A and B by the light source light emission condition deciding section 72.

(PWM Control)

The driving control of the light sources 4A and 4B herein is current control in which amplitudes of the current to be supplied to the light sources 4A and 4b are variable.

Meanwhile, the driving control of the LED may be performed by, instead of the current control, PWM (Pulse Width Modulation) in which a pulse width of the current to be supplied to the light sources 4A and 4B is variable.

The display system 100 can attain a similar effect to the above-described driving control even if the driving control for the light sources 4A and 4B is performed by PWM. Thus, the PWM control is explained below.

In the following, operations of the calculation section 7 and the members relating to the calculation section 7 are explained only as to differences from the above-described operations.

The calculation section memory 73 stores therein in advance a look-up table prescribing a relationship between (i) the results of the comparison between the luminance value indicated by the analysis result A and the luminance value indicated by the analysis result B and (ii) width adjustment of a pulse width per cycle of the current to be supplied to the light sources 4A and 4B. Hereinafter, the “pulse width per cycle of the current” is simply referred to as “current pulse width”.

The light source light emission condition deciding section 72 reads out the look-up table from the calculation section memory 73.

The look-up table has information for such a command that the pulse width of the current to be supplied to the light source 4A be shortened by a predetermined value, when the luminance value indicated by the analysis result A is greater than the luminance value indicated by the analysis result B. Moreover, the look-up table has information for such a command that the pulse width of the current to be supplied to the light source 4A be prolonged by a predetermined value, when the luminance value indicated by the analysis result A is smaller than the luminance value indicated by the analysis result B.

According to the information contained in the look-up table, the light source light emission deciding section 72 sends a light emission condition setting value A to the light source driving control section 8, the light emission condition setting value A shortening or prolonging, by a predetermined value, the pulse width of the current to be supplied to the light source 4A.

That is, when the luminance value indicated by the analysis result A is greater than the luminance value indicated by the analysis result B, the light emission condition setting value A is to command the light source driving control section 8 to shorten by a predetermined value the pulse width of the current to be supplied to the light source 4A. On the other hand, when the luminance value indicated by the analysis result A is smaller than the luminance value indicated by the analysis result B, the light emission condition setting value A is to command the light source driving control section 8 to prolong by a predetermined value the pulse width of the current to be supplied to the light source 4A.

On the contrary, the look-up table may be configured such that the look-up table has information for such a command that the pulse width of the current to be supplied to the light source 4B be prolonged by a predetermined value, when the luminance value indicated by the analysis result A is greater than the luminance value indicated by the analysis result B. Further, the look-up table may be configured such that the look-up table has information for such a command that the pulse width of the current to be supplied to the light source 4B be shortened by a predetermined value, when the luminance value indicated by the analysis result A is smaller than the luminance value indicated by the analysis result B. In these cases, the light source light emission condition deciding section 72 sends a light emission condition setting value B to the light source driving control section 8, the light emission condition setting value B shortening or prolonging by a predetermined value the pulse width of the current to be supplied to the light source 4B, like the light emission condition setting value A shortening or prolonging by a predetermined value the pulse width of the current to be supplied to the light source 4A.

The light source driving control section 8 receives the light emission condition setting value A or B.

The light source driving control section 8 may be, for example, a general LED driving circuit for supplying a PWM-modified current to the light sources 4A and 4B, thereby driving the light sources 4A and 4B.

Therefore, the light source driving control section 8 can easily generate a light source control signal A according to the light emission condition setting value A, the light source control signal A being the current to be applied to the light source 4A. That is, the light source driving control section 8 shortens or prolongs a current pulse width of the light source control signal A according to the light emission condition setting value A.

Likewise, the light source driving control section 8 can easily generate a light source control signal B according to the light emission condition setting value B, the light source control signal B being the current to be applied to the light source 4B. That is, the light source driving control section 8 shortens or prolongs a current pulse width of the light source control signal B according to the light emission condition setting value B.

The operation as described above is repeated until a difference between the luminance value indicated by the analysis result A and the luminance value indicated by the analysis result B becomes less than a predetermined value (for example, the value by which the pulse width of the current to be supplied to the light source 4A or 4B is shortened or prolonged by a single operation). The difference between the luminance value indicated by the analysis result A (the luminance value measured by the sensor 6A) and the luminance value indicated by the analysis result B (the luminance value measured by the sensor 6B) may be calculated out from the analysis results A and B by the light source light emission condition deciding section 72.

These configurations make it possible to attain substantially uniform luminance as a whole when the luminance of the image to be displayed on the A side of the liquid crystal panel 5 and the luminance of the image to be displayed on the B side of the liquid crystal panel 5 are different from each other due to (i) differences between the individual light sources 4A and 4B, (ii) asymmetric viewing characteristics of the liquid crystal panel 5, and (iii) mispositioning of the parallax barrier 52, or like cause. That is, the display system 100 can attain the aforementioned effect also in a case where the driving control of the light sources 4A and 4B is performed by PWM.

[Memory 10]

The light source driving control section 8 may be configured to read out information stored in the memory 10 and write information in the memory 10. This configuration makes it possible to (i) record, in the memory 10, information indicative of current values of the currents to be supplied to the light sources 4A and 4B at an end of operation, (ii) read out, from the memory 10, a current value that the light source control signal A has according to the light emission condition setting value A, and (iii) read out, from the memory 10, a current value that the light source control signal B has according to the light emission condition setting value B. The memory 10 may be provided inside the backlight section 300 or inside the other part of the display device section 200 (see FIG. 2).

This configuration makes it possible to attain substantially uniform luminance as a whole when the luminance of the image to be displayed on the A side of the liquid crystal panel 5 and the luminance of the image to be displayed on the B side of the liquid crystal panel 5 are different from each other due to (i) differences between the individual light sources 4A and 4B, (ii) asymmetric viewing characteristics of the liquid crystal panel 5, and (iii) mispositioning of the parallax barrier 52, or like cause.

[Another Embodiment 1 of BL Unit]

Next, another embodiment of a BL unit is described below, referring to FIG. 5. FIG. 5 is a view illustrating a BL unit (backlight unit) 20c, which is still another exemplary embodiment of the backlight unit.

Note that the BL unit 20c is different from the BL units 20a and 20b in that four light sources 4A, four light sources 4B, four light sources 4C, and four light sources 4D are provided along respective four sides of the light guide plate 2 (see FIG. 5). With the BL unit 20c, it is possible to realize a backlight suitable for CV display in which different images are displayed for 4 directions, namely upwards, downwards, rightwards, and leftwards.

An optical path changing member 1 of the BL unit 20c is preferably (i) a light diffusing sheet 1a in which the optical property (Φ<θ) is not directionally dependent or (ii) a light diffusing sheet 1a which has the optical property (Φ<θ) at least in a direction from the A side to the B side (or from the B side to the A side) and in a direction from the C side to the D side (or from the D side to the C side).

[Embodiment 2 of BL Unit]

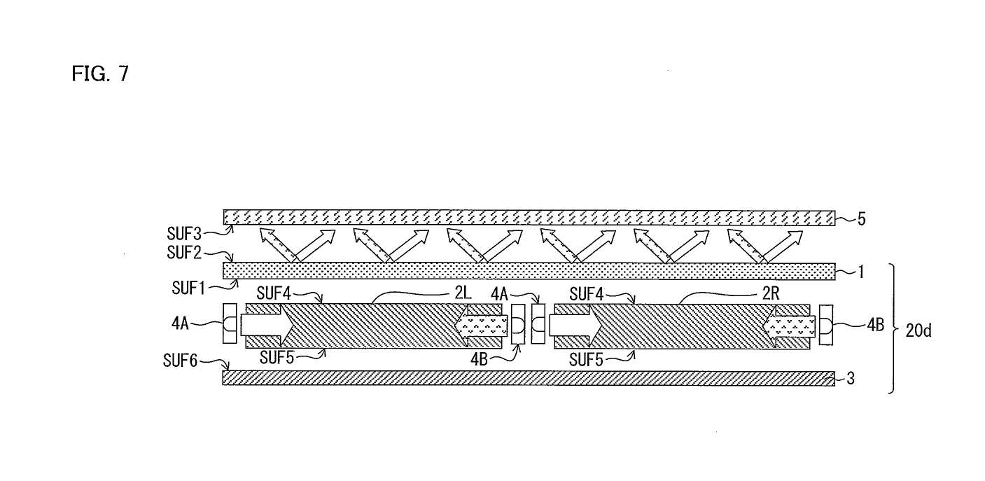

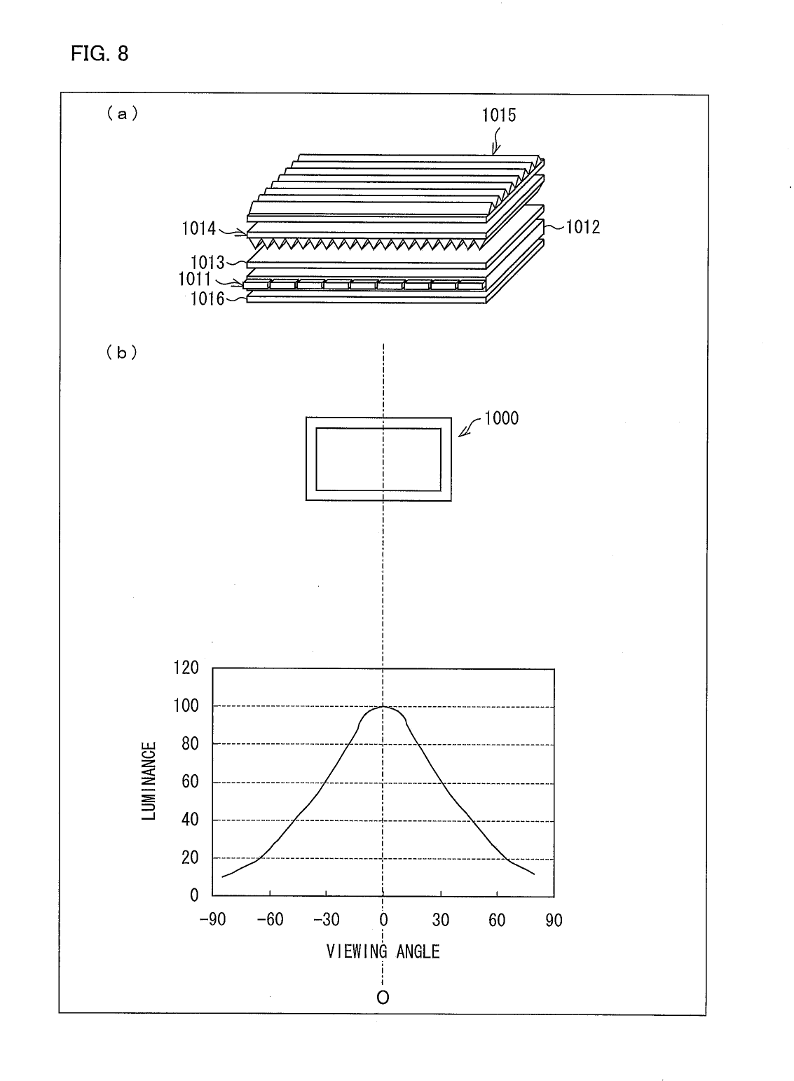

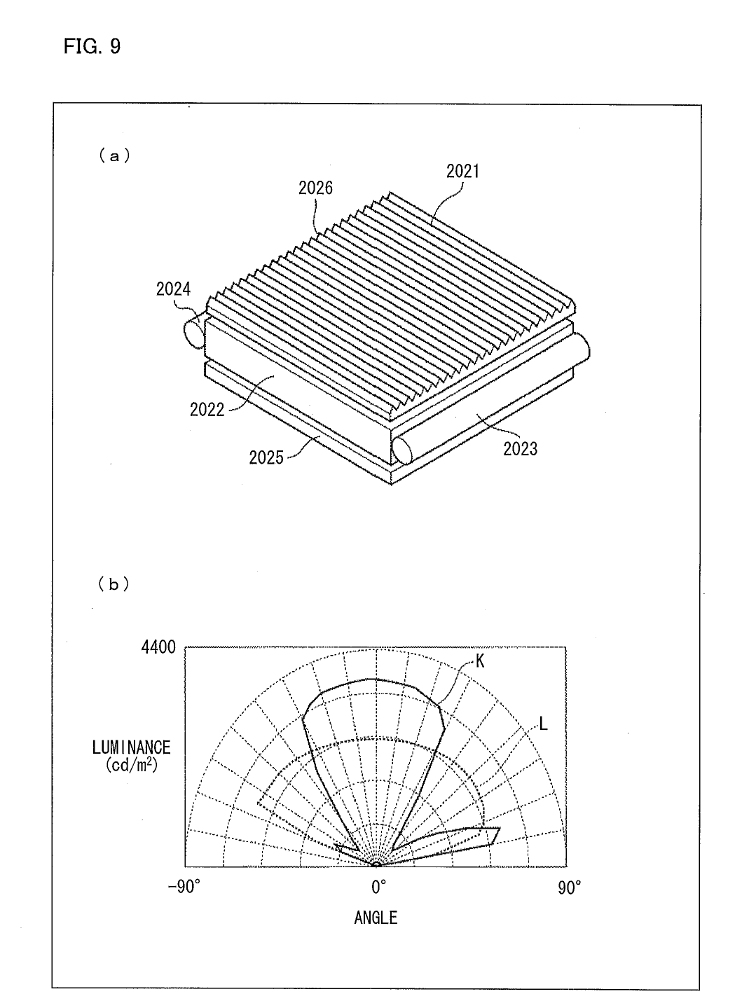

The following description will discuss Embodiment 2 of the BL unit of the present invention with reference to FIG. 7. FIG. 7 is a view illustrating a BL unit (backlight unit) 20d that is yet another example configuration of the backlight unit of the present invention.

Note that the BL unit 20d is different from the BL units 20a, 20b and 20c in that a plurality of light guide plates 2 (and corresponding light sources 4A and light sources 4B) are provided along a right-and-left direction of FIG. 7.

For example, as illustrated in FIG. 7, a light guide plate 2L and a light guide plate 2R are arranged so as to be adjacent to each other in a lateral direction (in the right-and-left direction) of a liquid crystal panel 5 in a plan view. Each of the light guide plates 2L and 2R has a configuration identical to that of the aforementioned light guide plate 2. That is, (i) the light guide plate 2L is provided with a light source 4A and a light source 4B on respective opposite side surfaces of the light guide plate 2L and (ii) the light guide plate 2R is provided with a light source 4A and a light source 4B on respective opposite side surfaces of the light guide plate 2R. Note that the number of sets each of which includes one (1) light guide plate 2 and corresponding light sources 4A and 4B is not limited to two as illustrated in FIG. 7. In accordance with the size of a liquid crystal panel 5, four or more sets can be provided in a BL unit. That is, the four or more sets can be arranged in a matrix manner.

Generally, as the number of reflections of light in a light guide plate is increased, an intensity of light having a low wavelength is gradually reduced. This causes a change in color of the light. Therefore, in a case where one (1) light guide plate is provided for a large-sized liquid crystal panel, the number of reflections of light in the light guide plate is increased. This causes a problem that color of light emitted from the light guide plate remarkably varies depending on whether the light is emitted from a part of the light guide plate, which part is closer to a light source or from a part of the light guide plate, which part is far from the light source. On the contrary, according to the configuration of the BL unit 20d, the plurality of light guide plates (the light guide plates 2L and 2R in FIG. 7) are thus arranged so as to be adjacent to each other. This makes it possible to reduce the size of each of the light guide plates 2L and 2R. It is therefore possible to prevent the number of reflections of light from being increased in each of the light guide plates 2L and 2R. This ultimately makes it possible to thin the BL unit 20d and increase the size of the liquid crystal panel 5 without causing a change in color of light (a variation in color of light).

(Another Shape of Light Guide Plate 2)

Like the above-described light guide plate 2, each bottom surface 5 of the light guide plates 2 of Embodiment 2 is prism-processed or dot-processed, in order to have uniform luminance or improved luminance.

Specifically, each light exit surface SUF4 of the light guides 2 of Embodiment 2 has (i) a thinly-formed convexoconcave shape in the vicinity of the light sources 4A, 4B, 4C and 4D (in four end parts of each of the light guide plates 2) and (ii) a densely-formed convexoconcave shape far from the light sources 4A, 4B, 4C and 4D (at the center of each of the light guide plates 2) so that light is uniformly emitted from the light exit surface SUF4. Note, however, that the light exit surface SUF4 is not limited to such convexoconcave shapes. Each of the light guide plates 2 of the present embodiment thus configured above allows light to be uniformly emitted substantially in four direction, i.e., diagonally forward up, diagonally forward down, diagonally forward left, and diagonally forward right (see FIG. 3).

### Another Description of the Present Invention

The present invention can also be described as below.

The backlight unit of the present invention can be configured such that the optical path changing member has an optical property in which a second light exit angle is smaller than a first light exit angle, where (i) the first light exit angle is an angle from a facing direction in which the at least two light sources face each other and an angle at which the light is emitted from the first light exit surface, and (ii) the second light exit angle is an angle from the facing direction and an angle at which the light is emitted from the second light exit surface.

As such, the optical path changing member has the optical property. Therefore, in a case where the second light exit angle is an angle other than 0°, the optical changing member can have a luminance directivity in which luminance distribution is maximum in at least two directions other than a direction normal to a display screen of a display panel.

The backlight unit of the present invention can be configured such that the second light exit surface has a plurality of prisms arranged in rows thereon, the plurality of prisms each having an axis perpendicular to the facing direction.

According to the configuration, the second light exit angle is smaller than the second light exit angle, where (i) the second light exit angle is an angle at which light is emitted from the second light exit surface after entering the optical path changing member at a predetermined incidence angle along the facing direction (which normally equals to a direction in which light emitted by the at least two light sources travels) and (ii) the second light exit angle is an angle at which the light is emitted from the first light exit surface. Therefore, unlike the backlight unit described in Patent Literature 2, the backlight unit of the present invention does not cause a problem that it is difficult to emit backlight having luminance directivities in different directions.

The backlight unit of the present invention can be configured such that each of the prisms has a vertex angle which falls within a range of not less than 80° but not more than 100°.

According to the configuration, in a case where (i) the first light exit angle falls within a range of not less than 60° but not more than 70° and (ii) the optical path changing member has a refractive index of approximately 1.5, it is possible to emit, from the second light exit surface of the optical path changing member, light having luminance directivities in respective directions of viewing angles of approximately ±45°.

The backlight unit of the present invention can be configured such that the optical path changing member contains light scattering fine particles which scatter light.

According to the configuration, it is possible to obtain desired total light transmittance and Haze by appropriately selecting (i) a base material, (ii) a material for the light scattering fine particles, (iii) an average particle diameter of the light scattering fine particles and/or (iv) a mixture ratio of the light scattering fine particles.

For example, in a case where the optical path changing member uniformly contains the light scattering fine particles, it can be said that the optical path changing member isotopically has the optical property though the optical property does not depend on direction.

Therefore, in this case, it is possible to realize a backlight unit suitable for, for example, so-called quartet view display (hereinafter referred to as “CV display”). Note that, in this case, the backlight unit requires at least two sets of light sources configured such that (i) in each of the at least sets of light sources, two light sources face each other and (ii) a facing direction, in which two light sources of one of the at least two sets of light sources face each other, is orthogonal to a facing direction, in which two light sources of the other of the at least two sets of light sources face each other.

The backlight unit of the present invention can be configured such that a minute convexoconcave structure is formed on the second light exit surface or a surface of the optical path changing member, which surface receives the light emitted from the first light exit surface of the light guide member.

According to the configuration, it is possible to obtain desired total light transmittance and Haze by appropriately adjusting convexoconcave intervals of the minute convexoconcave structure.

The backlight unit of the present invention can be configured such that the optical path changing member has a total light transmittance of not less than 50% and a Haze of not less than 70%.

According to the configuration, in a case where the first light exit angle falls within a range of not less than 65° but not more than 75°, it is possible to emit, from the second light exit surface of the optical path changing member, light having luminance directivities in respective directions of viewing angles of approximately ±45°.

The backlight unit of the present invention can be configured such that the light guide member includes a plurality of light guide members which are provided so as to be adjacent to each other in a lateral direction of the display panel in a plan view, and each of the plurality of light guide members is provided with the at least two light sources.

According to the configuration, a plurality of sets, each of which includes one (1) light guide member and corresponding at least two light sources, are provided in the lateral direction. It is therefore possible to realize a large-sized display panel which includes a backlight unit whose thickness is reduced.

Note here that a large-sized display panel including one (1) light guide member causes a problem that color of light is changed due to an increase in the number of reflections of the light in the light guide member. On the contrary, according to the configuration of the backlight unit of the present invention, the size of each of the plurality of light guide members is reduced. It is therefore possible to prevent the number of reflections of light from being increased in each of the plurality of light guide members. This makes it possible to increase the size of a display panel without causing a change (variation) in color of light.

The backlight unit of the present invention can be configured such that the first light exit angle falls within a range of not less than 60° but not more than 70°.

According to the configuration, in a case where the optical path changing member has a refractive index of approximately 1.5, it is possible to emit, from the second light exit surface of the optical path changing member, light having luminance directivities in respective directions of viewing angles of approximately ±45°.

The backlight unit of the present invention can be configured such that the first light exit angle falls within a range of not less than 65° but not more than 75°.

According to the configuration, it is possible to emit, from the second light exit surface of the optical path changing member, light having luminance directivities in respective directions of viewing angles of approximately ±45°.

A display device of the present invention can be configured to include: any one of the backlight units; and the display panel for displaying information on the display screen of the display panel by receiving the light emitted from the second light exit surface of the optical path changing member of the backlight unit.

According to the configuration, it is possible to realize a thin display device capable of emitting backlight having luminance directivities in different directions. It is therefore also possible to realize a display device capable of carrying out DV display or CV display.

For example, in a case where the at least two light sources are LEDs (Light Emitting Diodes), the backlight unit of the present invention causes, due to differences between the individual LEDs, a subsidiary problem that luminances are different from each other in the at least two directions other than the direction normal to the display screen of the display panel.

In order to address the subsidiary problem, the display device of the present invention can be configured to include: at least two luminance sensors which are provided in the respective at least two directions other than the direction normal to the display screen of the display panel, the at least two luminance sensors each detecting luminance of light emitted from the display screen; and a light source driving control section for adjusting a current to be supplied to the at least two light sources so that a difference between the luminances detected by the at least two luminance sensors is smaller than a predetermined luminance difference.

According to the configuration, the at least two luminance sensors are provided in the respective at least two directions other than the direction normal to the display screen of the display panel. It is therefore possible to detect the luminances of light in the respective at least two directions.

Further, according to the configuration, the light source driving control section adjusts the current to be supplied to the at least two light sources so that the difference between the luminances detected by the at least two luminance sensors is smaller than the predetermined luminance difference. It is therefore possible to reduce the difference which is caused between the luminances in the at least two directions due to the differences between the individual LEDs.

### Additional Description

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

### INDUSTRIAL APPLICABILITY

The backlight unit of the present invention can be employed as backlight units for use in various display devices. The backlight unit of the present invention is also widely applicable to, for example, electronics devices provided with various display panels which use backlight.

### REFERENCE SIGNS LIST

1: optical path changing member
1a: light diffusing sheet (optical path changing member)
1b: lens sheet (optical path changing member)
1c: prism
2, 2L, and 2R: light guide plate (light guide member)
3: reflection plate (reflection member)
4A and 4B: light source
5: liquid crystal panel (display panel)
6A and 6B: sensor (luminance sensor)
7: calculation section
8: light source driving control section
9: frame
10: memory
20, 20a, 20b, 20c, and 20d: BL unit (backlight unit)
71: data analysis section
72: light source light emission condition deciding section
73: calculation section memory
100: display system (display device)
200: display device section
300: backlight section
51 and 56: polarizing plate
52: parallax barrier
53: bonding layer
54: CF substrate
55: TFT substrate
SUF1: incidence surface (light receiving surface)
SUF2: light exit surface (second light exit surface)
SUF3: light illumination surface
SUF4: light exit surface (first light exit surface)
SUF5: bottom surface
SUF6: light reflection surface

1. A backlight unit, comprising:
at least two light sources which are provided so as to face each other;
a light guide member having a first light exit surface, the light guide member (i) receiving light emitted by the at least two light sources and (ii) emitting the light from the first light exit surface; and
an optical path changing member (i) directly receiving the light emitted from the first light exit surface and (ii) having a second light exit surface from which the light is emitted directly to a display panel that is externally provided, the optical path changing member for changing an optical path of the light passing through the optical path changing member,
the light emitted from the second light exit surface having a luminance directivity in which luminance distribution is maximum in at least two directions other than a direction normal to a display screen of the display panel.

2. The backlight unit as set forth in claim 1, wherein the optical path changing member has an optical property in which a second light exit angle is smaller than a first light exit angle, where (i) the first light exit angle is an angle from a facing direction in which the at least two light sources face each other and an angle at which the light is emitted from the first light exit surface, and (ii) the second light exit angle is an angle from the facing direction and an angle at which the light is emitted from the second light exit surface.

3. The backlight unit as set forth in claim 2, wherein the second light exit surface has a plurality of prisms arranged in rows thereon, the plurality of prisms each having an axis perpendicular to the facing direction.

4. The backlight unit as set forth in claim 3, wherein each of the prisms has a vertex angle which falls within a range of not less than 80° but not more than 100°.

5. The backlight unit as set forth in claim 2, wherein the optical path changing member contains light scattering fine particles which scatter light.

6. The backlight unit as set forth in claim 2, wherein a minute convexoconcave structure is formed on the second light exit surface or a surface of the optical path changing member, which surface receives the light emitted from the first light exit surface of the light guide member.

7. The backlight unit as set forth in claim 5, wherein the optical path changing member has a total light transmittance of not less than 50% and a Haze of not less than 70%.

8. The backlight unit as set forth in claim 1, wherein the light guide member includes a plurality of light guide members which are provided so as to be adjacent to each other in a lateral direction of the display panel in a plan view, and
each of the plurality of light guide members is provided with the at least two light sources.

9. The backlight unit as set forth in claim 4, wherein the first light exit angle falls within a range of not less than 60° but not more than 70°.

10. The backlight unit as set forth in claim 7, wherein the first light exit angle falls within a range of not less than 65° but not more than 75°.

11. A display device, comprising:
a backlight unit as set forth in claim 2; and
the display panel for displaying information on the display screen of the display panel by receiving the light emitted from the second light exit surface of the optical path changing member of the backlight unit.

12. The display device as set forth in claim 14, comprising:
at least two luminance sensors which are provided in the respective at least two directions other than the direction normal to the display screen of the display panel, the at least two luminance sensors each detecting luminance of light emitted from the display screen; and
a light source driving control section for adjusting a current to be supplied to the at least two light sources so that a difference between the luminances detected by the at least two luminance sensors is smaller than a predetermined luminance difference.

13. The display device as set forth in claim 11, wherein the display panel is capable of displaying different images in the respective at least two directions other than the direction normal to the display screen of the display panel.

14. The display device as set forth in claim 13, wherein the display panel is a liquid crystal panel including a parallax barrier.
